(19) United States
(12) Patent Application Publication
(10) Pub. No.: US 2026/0074535 A1
(43) Pub. Date: Mar. 12, 2026

(54) BATTERY MODULE AND VEHICLE

(71) Applicant: KABUSHIKI KAISHA TOSHIBA, Tokyo (JP)

(72) Inventors: Yohei UEMURA, Koganei Tokyo (JP); Wen ZHANG, Sagamihara Kanagawa (JP); Yoshihiko NAKANO, Yokohama Kanagawa (JP); Sayaka MORIMOTO, Kawasaki Kanagawa (JP); Ryosuke YAGI, Yokohama Kanagawa (JP)

(73) Assignee: KABUSHIKI KAISHA TOSHIBA, Tokyo (JP)

(21) Appl. No.: 19/290,460

(22) Filed: Aug. 5, 2025

(30) Foreign Application Priority Data
Sep. 6, 2024 (JP) 2024-153623

(51) Int. Cl. H02J 7/00; H01M 10/44; H01M 50/249; H01M 50/512; H01M 50/581

(52) U.S. Cl. CPC H02J 7/65; H01M 10/441; H01M 10/443; H01M 50/249; H01M 50/512; H01M 50/581; H02J 7/663; H02J 7/855; H01M 2200/103

(57) ABSTRACT

According to an embodiment, a battery module includes a cell group in which a first cell and a second cell are connected in parallel, a first circuit breaker mechanism configured to disconnect connection between the first cell and the second cell when a temperature of the first cell is equal to or higher than a first temperature, and a connection mechanism configured to connect the first cell to a discharge circuit when the temperature of the first cell is equal to or higher than a second temperature higher than the first temperature.

### CROSS-REFERENCE TO RELATED APPLICATION(S)

This application is based upon and claims the benefit of priority from Japanese Patent Application No. 2024-153623, filed Sep. 6, 2024, the entire contents of which are incorporated herein by reference.

### FIELD

Embodiments described herein relate generally to a battery module and a vehicle.

### BACKGROUND

In the battery module, when one of the single cells connected in parallel is short-circuited, a short-circuit current flows between the one single cell and the other adjacent single cell, Joule heat is generated, and heat may propagate in the battery module.

### BREIF DESCRIPTION OF THE DRAWINGS

FIG. 1 is a graph showing the amount of heat generated at each temperature in a positive electrode of a lithium-ion secondary battery.

FIG. 2 is a flowchart showing an example of an event in the battery module according to the embodiment.

FIG. 3 is a schematic view showing a positional relationship between a first circuit breaker mechanism and a connection mechanism in a circuit.

FIG. 4 is a schematic diagram showing a connection structure between a first cell and a second cell when a temperature of the first cell is lower than a first temperature.

FIG. 5 is a schematic diagram showing a connection structure between a first cell and second cell when temperature of first cell is equal to or higher than first temperature and lower than second temperature.

FIG. 6 is a schematic diagram showing a connection structure between a first cell and a second cell when the temperature of the first cell is equal to or higher than a second temperature.

FIG. 7 is a schematic diagram showing a connection structure between a first cell and a second cell in the case where a first circuit breaker mechanism is further provided.

FIG. 8 is a cross-sectional view schematically showing a connection structure of members in the battery module according to the embodiment.

FIGS. 9A and 9B are schematic views showing a connection portion between a first bus bar and a second bus bar of the battery module according to the embodiment.

FIGS. 10A and 10B are schematic views showing a connection portion between a first bus bar and a board terminal of the battery module according to the embodiment.

FIG. 11 is a flowchart showing a modification of an event in the battery module according to the embodiment.

FIG. 12 is a block diagram showing an example of a battery module according to an embodiment.

FIG. 13 is an example of a flowchart executed by the control circuit of the battery module according to the embodiment.

FIG. 14 is a block diagram showing a modification of the battery module according to the embodiment.

FIG. 15 is a flowchart showing a modification of an event in the battery module according to the embodiment.

FIG. 16 is a schematic view showing a connection structure of single cells in the battery module according to the embodiment.

FIG. 17 is a partially transparent view schematically showing an example of a vehicle according to an embodiment.

FIG. 18 is a diagram schematically showing an example of a control system related to an electric system in the vehicle according to the embodiment.

### DETAILED DESCRIPTION

In general, according to an embodiment, a battery module includes a cell group in which a first cell and a second cell are connected in parallel, a first circuit breaker mechanism configured to disconnect connection between the first cell and the second cell when a temperature of the first cell is equal to or higher than a first temperature, and a connection mechanism configured to connect the first cell to a discharge circuit when the temperature of the first cell is equal to or higher than a second temperature higher than the first temperature.

Hereinafter, embodiments will be described with reference to the drawings. In the following description, components having the same or similar functions are denoted by the same reference numerals throughout the drawings, and redundant description thereof will be omitted. The drawings are schematic views for explaining the embodiments and promoting the understanding thereof, and the shapes, dimensions, ratios, and the like thereof may be different from those of an actual device, but these can be appropriately changed in design in consideration of the following description and known techniques.

The following description will be made on the assumption that the battery in the battery module is a lithium-ion secondary battery. The battery includes a positive electrode and a negative electrode as electrodes, and the positive electrode and the negative electrode have opposite polarities. In each of the positive electrode and the negative electrode of the battery, the potential changes in response to the change in the state of charge. Each of the positive electrode and the negative electrode has a predetermined relationship between the potential and the state of charge. Thus, for each of the electrodes of the battery, the potential can be calculated based on the state of charge, and the state of charge can be calculated based on the potential.

The battery module has two or more single cells forming a cell group, and the single cells in the cell group are connected in parallel. The following description will be made on the assumption that the first cell and the second cell are adjacent to each other.

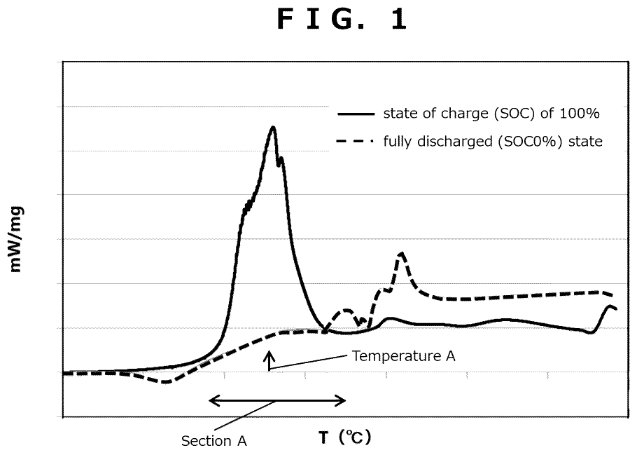

The temperature of the single cell may rapidly increase due to various external factors. In the battery module, when one single cell generates heat, the single cell adjacent to the one single cell also receives the propagation of the heat, and a rapid temperature rise propagates. FIG. 1 shows the results of differential scanning calorimetry (DSC) on the positive electrode of the lithium-ion secondary battery, and shows the amount of heat generated at each temperature. In FIG. 1, the temperature increases toward the right, and the amount of heat generated increases toward the top. The solid line indicates a state of charge (SOC) of 100%, and the broken line indicates a fully discharged (SOC 0%) state. When the SOC is 100%, the peak of the amount of heat generation is near the temperature A degrees. On the other hand, when the SOC is lowered and the battery is completely discharged, the temperature at which the amount of heat generation increases is shifted to the high temperature side, and the decrease in the amount of heat generation in the vicinity of the section A including the temperature A can be observed from FIG. 1. Therefore, in the present invention, before the rapid heat generation of the single cell starts, the single cell is discharged to lower the SOC, the height of the peak of the heat generation amount (vertical axis) is lowered, and the position of the peak itself is shifted to the right. This makes it possible to alleviate a rapid temperature rise of the battery module.

In the description of the embodiments, connection or disconnection means electrical connection or disconnection unless otherwise specified.

### First Embodiment

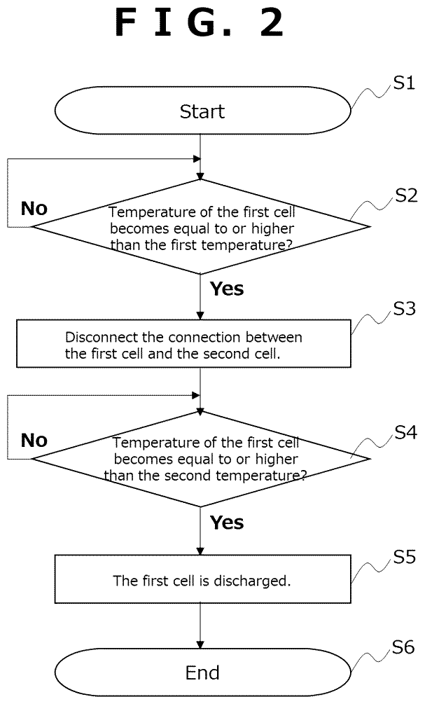

In the first embodiment, a battery module will be described. FIG. 2 is a flowchart showing an example of a flow of events in the battery module according to the embodiment. A battery module includes a first circuit breaker mechanism and a connection mechanism in a cell group in which a first cell and a second cell are connected in parallel. The first circuit breaker mechanism disconnects the connection between the first cell and the second cell when the temperature of the first cell in the battery module according to the embodiment is equal to or higher than a first temperature. The connection mechanism connects the first cell to the discharge circuit when the temperature of the first cell is equal to or higher than a second temperature higher than the first temperature. In the following description of the embodiments, a case when the temperature of the first cell monotonously increases will be described.

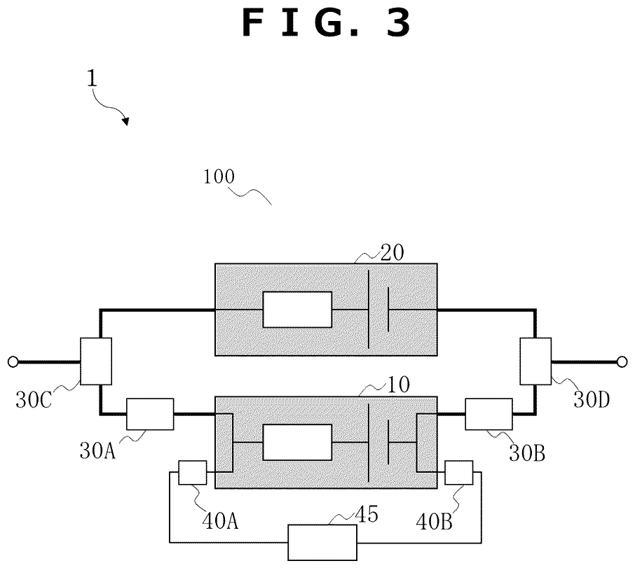

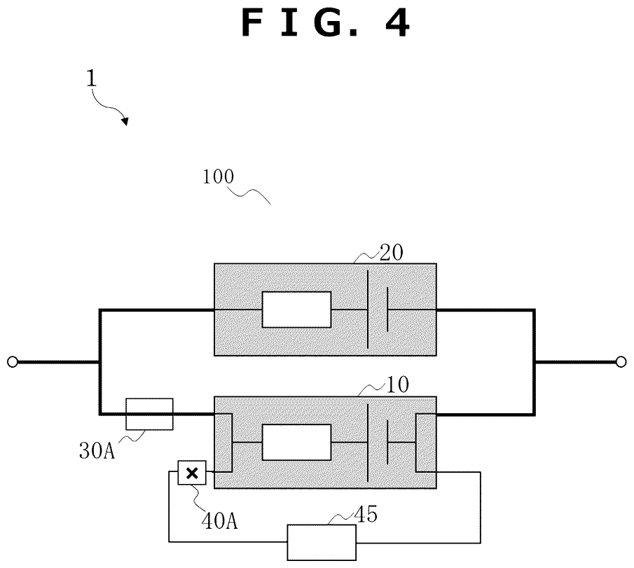

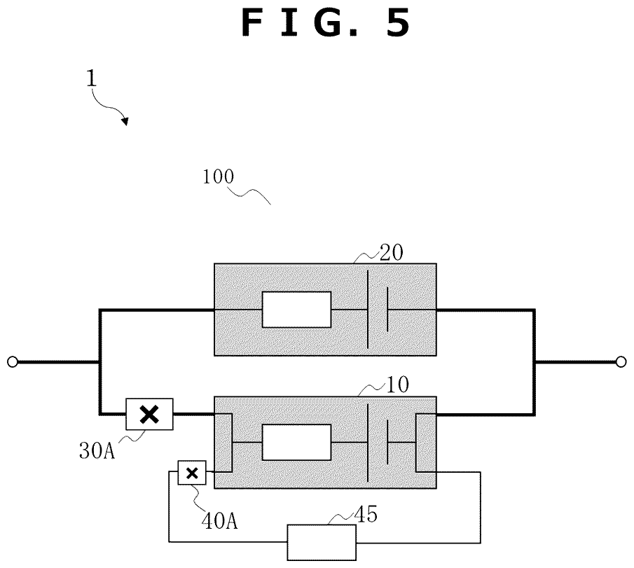

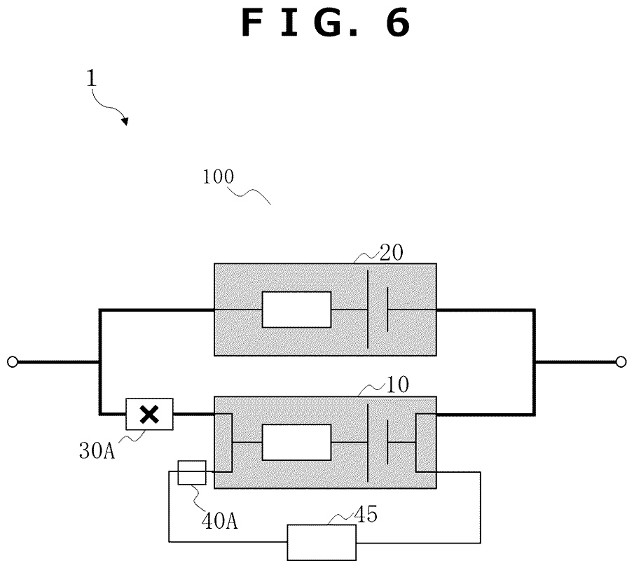

FIGS. 3, 4, 5, and 6 show the cell group 100 in the battery module 1, and FIGS. 4, 5, and 6 are schematic views showing the connection structure of the first cell 10 according to the temperature. FIG. 4 shows a case when the temperature of the first cell 10 is lower than the first temperature, FIG. 5 shows a case when the temperature is equal to or higher than the first temperature and lower than the second temperature, and FIG. 6 shows a case when the temperature is equal to or higher than the second temperature.

In FIGS. 3, 4, 5, and 6, the battery module 1 includes a cell group 100. The cell group 100 includes a first cell 10, a second cell 20, a first circuit breaker mechanism 30, a connection mechanism 40, and a discharge circuit 45. In the drawing, 30A, 30B, 30C, and 30D represent positions where the first circuit breaker mechanism 30 can be installed, and 40A and 40B represent positions where the connection mechanism 40 can be installed. The 30A is provided in the circuit on the first cell 10 side between the positive electrode of the first cell 10 and the positive electrode of the second cell 20. The 30B is provided in the circuit on the first cell 10 side between the negative electrode of the first cell 10 and the negative electrode of the second cell 20. The 30C is provided between the positive electrode of the first cell 10 and the positive electrode of the second cell 20, and at a location where the first cell 10 and the second cell 20 are branched. The 30D is provided between the negative electrode of the first cell 10 and the negative electrode of the second cell 20, and at a place where the first cell 10 and the second cell 20 are branched. The 40A is provided between the positive electrode of the first cell 10 and the discharge circuit 45. The 40B is provided between the negative electrode of the first cell 10 and the discharge circuit 45. Hereinafter, the positions where the first circuit breaker mechanism 30 and the connection mechanism 40 are installed will be described using reference numerals. The drawings in the first circuit breaker mechanism 30 and the connection mechanism 40 in FIGS. 4, 5, and 6 show the connection state of each mechanism in the circuit. When each mechanism is conducted, it is connected by a solid line, and when it is disconnected, it is represented by X.

The first cell 10 and the second cell 20 are single cells and are connected in parallel to each other. The first cell 10 and the second cell 20 may include a resistance. The resistance included in the first cell 10 and the second cell 20 is, for example, internal resistance.

The first circuit breaker mechanism 30 disconnects the connection between the first cell 10 and the second cell 20 when the temperature of the first cell 10 becomes equal to or higher than a first temperature. Thus, for example, even if the first cell 10 is short-circuited, a short-circuit current flowing between the first cell 10 and the second cell 20 can be prevented. In FIG. 3, the first circuit breaker mechanism 30 is installed in at least one of 30A, 30B, 30C, and 30D. In order to further extend the life of the cell module, it is desirable that the first circuit breaker mechanism 30 is provided in the 30A or the 30B. Thus, only the first cell 10 can be disconnected, and the operation of the second cell 20 can be continued. In order to perform the disconnection more reliably, a plurality of first circuit breaker mechanisms 30 may be provided.

The connection mechanism 40 electrically connects the first cell 10 and the discharge circuit 45 when the temperature of the first cell 10 becomes equal to or higher than the second temperature. Thus, the SOC of the first cell 10 can be decreased before the temperature of the first cell 10 rapidly increases. In FIG. 3, the connection mechanism 40 is installed at least one of the 40A and the 40B.

The discharge circuit 45 is disconnected or conducted to the first cell 10 via the connection mechanism 40 according to the temperature of the first cell 10. The discharge circuit 45 is, for example, a capacitor or a resistor. The resistance value of the discharge circuit 45 may be smaller or larger than the resistance value of the first cell 10. The resistance value may be a resistance value at which a current flows through the discharge circuit 45, and may be, for example, a resistance value four times the resistance value of the first cell 10. This allows a current to flow through the discharge circuit 45 rather than the first cell 10, and can prevent an excessive current from flowing through the first cell 10. The discharge circuit 45 is connected in parallel to the first cell 10.

The flow of events in the battery module according to the embodiment will be described with reference to the flowchart of FIG. 2 and schematic views of FIGS. 4 to 6 showing the first cell 10 and the connection structure around the first cell 10. The flowchart of FIG. 2 is an example, and the order of events is not limited as long as a required result can be obtained. The first circuit breaker mechanism 30 is disposed between the positive electrode of the first cell 10 and the positive electrode of the second cell 20 and on the first cell 10 side (30A), and the connection mechanism 40 is disposed between the positive electrode of the first cell 10 and the discharge circuit 45 (40A). The temperature of the first cell 10 can be constantly measured by a temperature sensor, a thermosensor, or the like.

In S2, when the temperature of the first cell 10 becomes equal to or higher than the first temperature (YES), the process proceeds to S3. When the temperature of the first cell 10 has not reached the first temperature (NO), the S2 is repeated. The connection structure around the first cell 10 at this time is as shown in FIG. 4, and the first cell 10 is electrically connected to the second cell 20. On the other hand, the first cell 10 is disconnected from the discharge circuit 45 by the connection mechanism 40.

In the S3, the first circuit breaker mechanism 30 disconnects the connection between the first cell 10 and the second cell 20. In detail, the first circuit breaker mechanism 30 disconnects the circuit in the 30A. The connection structure around the first cell 10 is shown in FIG. 5 because the temperature of the first cell 10 is equal to or higher than the first temperature and lower than the second temperature. The first cell 10 and the second cell are disconnected. The first cell 10 is also disconnected from the discharge circuit 45.

In S4, when the temperature of the first cell 10 becomes equal to or higher than the second temperature (YES), the process proceeds to S5. When the temperature of the first cell 10 has not reached the second temperature (NO), the S4 is repeated. The connection structure around the first cell 10 is shown in FIG. 5.

In the S5, the first cell 10 is discharged by the connection mechanism 40. Specifically, the connection mechanism 40 connects the first cell 10 and the discharge circuit 45. The connection structure around the first cell 10 is shown in FIG. 6 because the temperature of the first cell 10 is equal to or higher than the second temperature. The first cell 10 is not connected to the second cell 20. On the other hand, the first cell 10 is connected to the discharge circuit 45. The SOC of the first cell 10 can be decreased by the discharge. When the SOC of the first cell 10 is 50% or less, a rapid temperature rise of the first cell 10 is less likely to occur.

The first temperature and the second temperature will be described. The first temperature and the second temperature are set to be higher than the temperature during normal operation and lower than the temperature at which a rapid temperature rise occurs in the first cell 10. The second temperature is set to be higher than the first temperature. The normal operation refers to a state when the first cell 10 has not reached a heat generation start temperature described later. Whether the temperature is higher than the temperature during normal operation can be determined in advance by using, for example, a DSC, an Accelerating Rate Calorimetry (ARC), or the current or voltage flowing through the battery module 1, and the temperature range for normal operation can be set in accordance with the form of the battery module. The measurement can be used as a reference when the first temperature and the second temperature are set. The rapid temperature rise is a state where exothermic reactions occur consecutively, and the temperature at which the rapid temperature rise starts is higher than the heat generation start temperature at which heat generation gradually starts. In order to more reliably mitigate the rapid temperature rise, the second temperature is preferably a temperature lower than the heat generation start temperature at which heat generation gradually starts. The heat generation start temperature can be measured by DSC, ARC, or the like. In the DSC, for example, the temperature at which the calorific value becomes a value larger than 0 can be set as the heat generation starting temperature. In the ARC, for example, a temperature at which the temperature increases by 0.02° C. per minute can be set as the heat generation start temperature. The first temperature can be set to, for example, a temperature obtained by subtracting the temperature difference between the first circuit breaker mechanism 30 and the connection mechanism 40 from the second temperature. In calculating the first temperature, an error of the temperature sensor may be considered. When the first cell 10 is a lithium-ion secondary battery, the first temperature is, for example, 130° C., and the second temperature is, for example, 150° C.

By discharging after the connection between the first cell 10 and the other single cells is disconnected in this way, it is possible to prevent a cross current from occurring between the first cell 10 and the second cell 20. Further, when only the first cell 10 is discharged, the amount of heat generated by the entire battery module 1 can be suppressed.

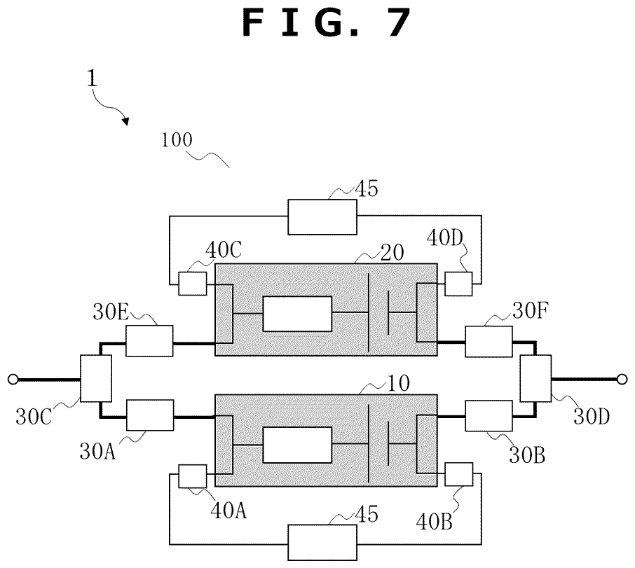

The first circuit breaker mechanism 30, the connection mechanism 40, and the discharge circuit 45 can also be provided in the second cell 20. The locations where the first circuit breaker mechanism 30, the connection mechanism 40, and the discharge circuit 45 are installed in the second cell 20 will be described with reference to FIG. 7. The discharge circuit 45 is connected in parallel to the second cell 20, as in the case of the first cell 10. The 30E is provided in the circuit on the second cell 20 side between the positive electrode of the second cell 20 and the positive electrode of the first cell 10. The 30F is provided in the circuit on the second cell 20 side between the negative electrode of the second cell 20 and the negative electrode of the first cell 10. The 40C is provided between the positive electrode of the second cell 20 and the discharge circuit 45. The 40D is provided between the negative electrode of the second cell 20 and the discharge circuit 45.

The first temperature and the second temperature can be changed as appropriate in accordance with the design of the first cell 10 and the surrounding environment.

Hereinafter, a case where each member is used for the first circuit breaker mechanism and the connection mechanism will be described. First, a battery module in which the first circuit breaker mechanism is made of metal and the connection mechanism is made of an insulator will be described.

The metal used as the first circuit breaker mechanism is a metal that melts at a temperature equal to or higher than the first temperature. The insulator used for the connection mechanism is an insulator that melts at the second temperature or higher.

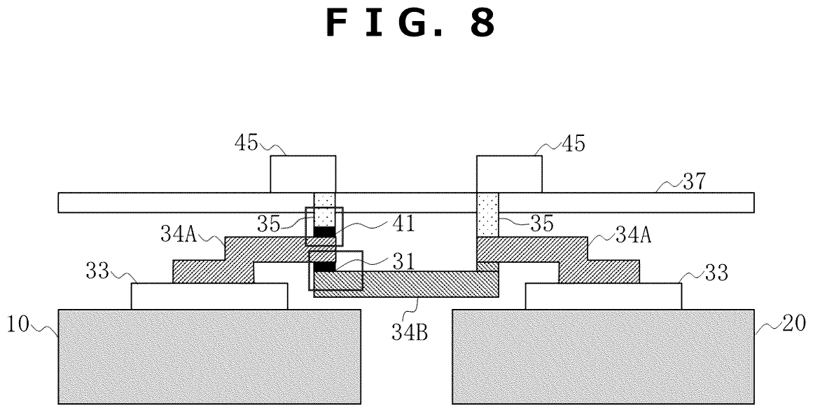

FIG. 8 is a cross-sectional view schematically showing a connection structure of each member in the battery module 1 according to the embodiment. In the embodiment, the cell module 1 includes the first cell 10, the second cell 20, the metals 31, the cell terminals 33, the first bus bar 34A, the second bus bar 34B, the board terminals 35, the circuit board 37, the insulators 41, and the discharge circuit 45. The first cell 10 and the second cell 20 are connected to the first bus bar 34A via the cell terminals 33. The first bus bar 34A and the second bus bar 34B are connected via the metals 31 when the first cell 10 is at a temperature lower than the first temperature. The first bus bar 34A and the board terminals 35 are disconnected when the first cell 10 is less than the second temperature. The board terminal 35 mechanically connects the discharge circuit 45 and the insulator 41 via the circuit board 37. The board terminal 35 and the discharge circuit 45 are electrically connected. The board terminal 35 and the insulator 41 are electrically connected to each other at a temperature lower than the second temperature. The discharge circuit 45 is located on the opposite side of the circuit board 37 from the first cell 10 and the second cell 20 so as not to apply heat to the first cell 10 and the second cell 20.

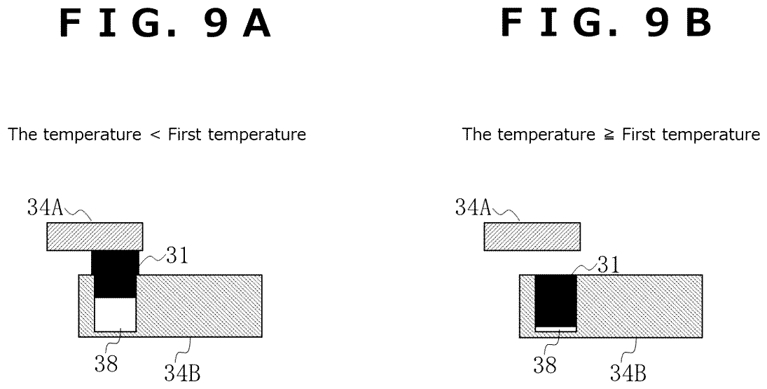

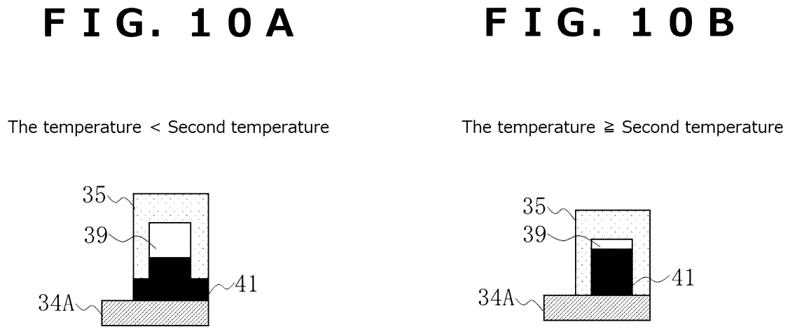

When the metals 31 and the insulators 41 are melted, the connection state between the first bus bar 34 and the second bus bar 34B can be changed. As a method for changing the connection state more clearly, for example, a groove 38 or a cavity 39 can be provided as shown in FIGS. 9 and 10.

The metals 31 mechanically connect the first bus bar 34A and the second bus bar 34B when the temperature of the first cell 10 is lower than the first temperature. Thus, the first bus bar 34A and the second bus bar 34B are connected to each other. FIG. 9 is a schematic view showing the connecting portion between the first bus bar 34A and the second bus bar 34B at each temperature, and FIG. 9A shows a case when the temperature is lower than the first temperature, and FIG. 9B shows a case when the temperature is equal to or higher than the first temperature. The second bus bar 34B is provided with a groove 38, and the metals 31 melt when the temperature of the first cell 10 becomes equal to or higher than the first temperature. The metal 31 melts at, for example, 140° C. or less. The metal 31 is, for example, a SnBi-based alloy, a SnIn-based alloy, or a SnZn-based alloy.

The insulators 41 are mechanically connected to the first bus bar 34A and the board terminals 35 when the temperature of the first cell 10 is lower than the second temperature. Thus, the insulators 41 disconnect the first bus bars 34A from the board terminals 35. FIG. 10 is a schematic view showing the connecting portion between the first bus bar 34A and the board terminals 35 at each temperature, and FIG. 10A shows a case when the temperature is lower than the second temperature, and FIG. 10B shows a case when the temperature is equal to or higher than the second temperature. The board terminal 35 is provided with a cavity 39, and the insulator 41 melts when the temperature of the first cell 10 becomes equal to or higher than the second temperature. The insulator 41 melts at, for example, 160° C. or lower. The insulator 41 is made of, for example, polyethylene, polypropylene, polystyrene, vinyl chloride resin, polycarbonate, or polyacetal.

The groove 38 and the cavity 39 serve to contain the molten metal 31 and the insulator 41. The shape of the groove 38 and the cavity 39 is not limited as long as the metal 31 and the insulator 41 can be peeled off from the respective connection portions to be electrically connected or disconnected. By providing the groove 38 and the cavity 39, the molten metal 31 and the insulator 41 do not remain at the original positions but move to the groove 38 and the cavity 39, and thus, it is possible to quickly perform conduction and disconnection. In addition to the groove 38 and the cavity 39, for example, by adjusting the interval between the first bus bar 34A and the second bus bar 34B, conduction or disconnection of the respective connecting portions can be appropriately controlled.

The metals 31 are installed at positions where the first circuit breaker mechanisms 30 are disposed, and can be installed at at least one of 30A, 30B, 30C, and 30D in FIG. 3. The insulator 41 is installed at a position where the connection mechanism 40 is disposed, and can be installed at at least one of a 40A and a 40B in FIG. 3.

A combination of desirable positions in the case where the metal 31 and the insulator 41 are disposed will be described with reference to FIG. 3. When the metals 31 are provided on the 30A, the insulators 41 are desirably provided on the 40A. When the metals 31 are provided on the 30B, the insulators 41 are desirably provided on the 40B. With the metal 31 and the insulator 41 in these arrangements, the metal 31 and the insulator 41 refer to similar temperature zones, and the insulator 41 melts after the metal 31 melts. Therefore, the first cell 10 can be connected to the discharge circuit 45 in a state where the circuit is more reliably disconnected. Therefore, the battery module 1 can be operated with higher reliability. The metals 31 and the insulators 41 may be provided at positions separated from each other, and for example, the metals 31 may be provided on the 30A and the insulators 41 may be provided on the 40B.

The melting temperature of the metal 31 and the insulator 41 can be controlled by changing the composition thereof.

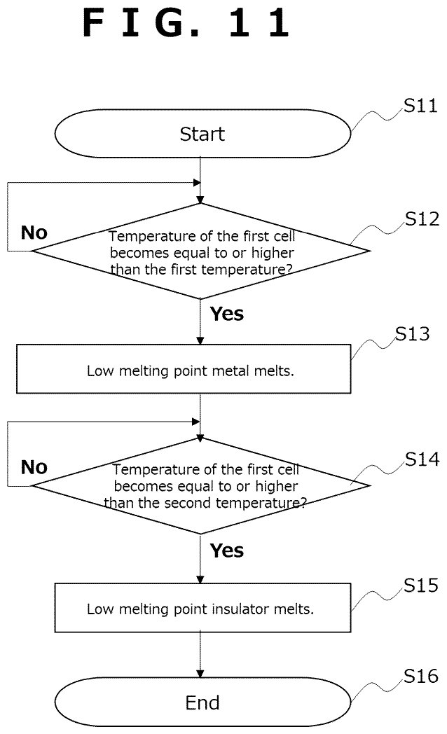

A flow of events in the battery module according to the embodiment will be described. FIG. 11 is a flowchart showing a modification of the flow of events in the battery module according to the embodiment. It is assumed that the temperature of the first cell 10 gradually increases and events occur in the order of the steps.

In S12, when the temperature of the first cell 10 becomes equal to or higher than the first temperature (YES), the process proceeds to S13. When the temperature of the first cell 10 has not reached the first temperature (NO), the S12 is repeated. The connection structure between the first bus bar 34A and the second bus bar 34B at this time is shown in FIG. 9A, and the connection structure between the first bus bar 34A and the board terminals 35 is shown in FIG. 10A. The first bus bar 34A and the second bus bar 34B are connected to each other, but the first bus bar 34A and the board terminals 35 are not connected to each other.

In the S13, when the temperature of the first cell 10 reaches the first temperature, the metals 31 melt, and the connection between the first bus bar 34A and the second bus bar 34B is disconnected. When the metal 31 is melted, the metal 31 moves to the groove 38. Even if the metals 31 do not entirely move to the groove 38, the connection between the first bus bar 34A and the second bus bar 34B may be disconnected. The connection structure between the first bus bar 34A and the second bus bar 34B at this time is shown in FIG. 9B because the temperature of the first cell 10 is equal to or higher than the first temperature and lower than the second temperature, and the connection structure between the first bus bar 34A and the board terminals 35 is shown in FIG. 10A.

In S14, when the temperature of the first cell 10 becomes equal to or higher than the second temperature (YES), the process proceeds to S15. When the temperature of the first cell 10 has not reached the second temperature (NO), the S14 is repeated. The connection structure between the first bus bar 34A and the second bus bar 34B at this time is shown in FIG. 9B, and the connection structure between the first bus bar 34A and the board terminals 35 is shown in FIG. 10A.

In the S15, when the temperature of the first cell 10 reaches the second temperature, the insulators 41 melt, and the first bus bars 34A and the board terminals 35 are connected. When the insulator 41 melts, the insulator 41 moves to the cavity 39. The first bus bar 34A and the board terminals 35 may be connected to each other even if the entire insulator 41 does not move to the cavity 39. The connection structure between the first bus bar 34A and the second bus bar 34B at this time is shown in FIG. 9B, and the connection structure between the first bus bar 34A and the board terminals 35 is shown in FIG. 10B.

By using a metal or an insulator in this manner, it is possible to disconnect or connect a circuit without installing a new component.

Next, a case where the battery module includes a control circuit, the first circuit breaker mechanism includes a first circuit breaker, and the connection mechanism includes a connection circuit will be described.

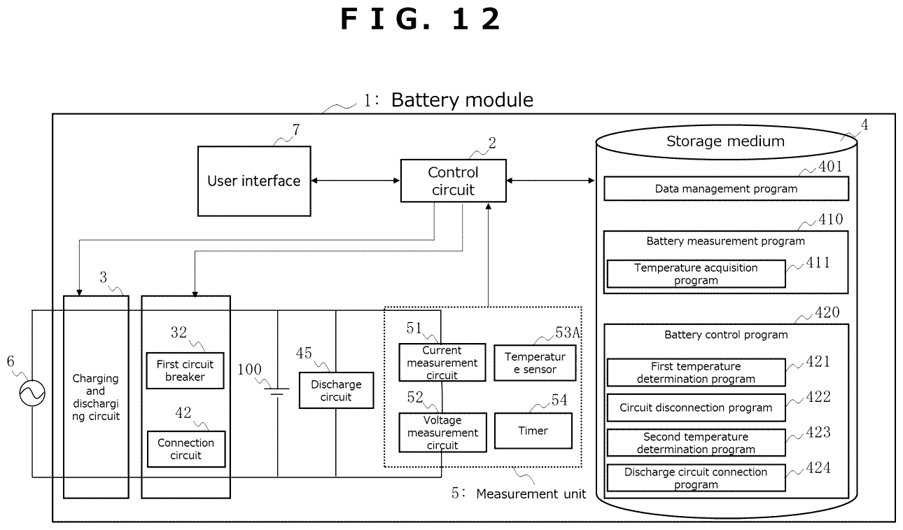

FIG. 12 is a block diagram showing an example of a schematic view of the battery module 1 according to the embodiment. The battery module 1 according to the embodiment includes a control circuit 2, a charge and discharge circuit 3, a storage medium 4, a measurement unit 5, a power supply 6, a cell group 100, a first circuit breaker 32, and a connection circuit 42. The storage medium 4 stores a data management program 401 capable of managing input and output of data, a battery measurement program 410 for measuring the SOC, voltage, and temperature of the first cell 10 and the second cell 20 in the cell group 100, and a battery control program 420 for controlling the first cell 10 and the second cell 20. The measurement unit 5 includes a current measurement circuit 51 that measures the current of the first cell 10 and the second cell 20, a voltage measurement circuit 52 that measures the voltage of the first cell 10 and the second cell 20, temperature sensors 53A, and a timer 54. The cell module 1 may further include a temperature sensor 53B and a user interface 7.

The battery measurement program 410 includes a temperature acquisition program 411 for acquiring the temperature of the first cell 10. The battery control program 420 includes a first temperature determination program 421 for comparing the temperature of the first cell 10 with the first temperature, a circuit disconnection program 422 for disconnecting the first cell 10 from the second cell 20, a second temperature determination program 423 for comparing the temperature of the first cell 10 with the second temperature, and a discharge circuit connection program 424 for connecting the first cell 10 to the discharge circuit 45. The programs included in the battery control program 420 do not need to be stored in the storage medium 4. For example, the plurality of programs stored in the storage medium 4 may be stored in different storage media, or may be operated in a cloud. The plurality of programs stored in the storage medium 4 may be executed by a device including a plurality of control circuits 2 or an external control circuit.

The battery module 1 is a device including a lithium-ion secondary battery, and examples thereof include a large power storage device for a power system, a smartphone, a vehicle, a stationary power supply device, and a robot. Examples of the vehicle serving as the battery module 1 include a railway vehicle, an electric bus, an electric vehicle, a plug-in hybrid vehicle, and an electric motorcycle.

The control circuit 2 is configured by a processor, an integrated circuit, or the like, and the processor or the like configuring the control circuit 2 includes any of a central processing unit (CPU), an application specific integrated circuit (ASIC), a microcontroller unit (microcontroller), a field programmable gate array (FPGA), a digital signal processor (DSP), and the like. The control circuit 2 may be configured by one processor or the like, or may be configured by a plurality of processors or the like. The control circuit 2 reads and executes a program stored in the storage medium 4, and controls charging and discharging of the cell group 100 via the charging and discharging circuit 3. The control circuit 2 switches, for example, the state of the charge and discharge circuit 3, and switches between a state in which the cell group 100 is charged and a state in which the cell group 100 is discharged. In a state when the cell group 100 is charged, the control circuit 2 controls driving of the power supply 6 that supplies power to the cell group 100 and charging and discharging by the charging and discharging circuit 3, and the magnitude of current input to the cell group 100 and the like are adjusted.

The control circuit 2 reads the battery measurement program 410 from the storage medium 4 and executes the battery measurement program 410 to measure the SOC of each single cell in the cell group 100. The control circuit 2 can acquire measurement results of parameters related to the single cells in the cell group 100, including data related to the current values and voltage values of the single cells in the cell group 100, from the measurement unit 5, and input measurement data including these measurement results and data related to the calculated SOC to the storage medium 4. The measurement data includes a measurement value, a change amount (time history), and the like at each of a plurality of measurement points. Further, the measurement data may include a change amount (time history) of a current of a single cell in the cell group 100, a change amount (time history) of a voltage of a single cell in the cell group 100, and a change amount (time history) of a temperature of a single cell in the cell group 100. The control circuit 2 reads the battery control program 420 from the storage medium 4 and executes the battery control program 200 to perform processing described later.

The charge and discharge circuit 3 is provided with, for example, an AC/DC converter, a transformer circuit, and the like. In the charge and discharge circuit 3, the AC/DC converter or the like converts AC power from the power supply 6 into DC power, and the voltage transformer circuit or the like transforms the voltage of the power supplied from the power supply 6 into a voltage corresponding to the cell group 100. As a result, DC power is supplied to the cell group 100 at a voltage corresponding to the cell group 100, and a charging current is input to the cell group 100.

The storage medium 4 is a storage device called a main storage device or an auxiliary storage device. The storage medium 4 is a magnetic disk, an optical disk (CD-ROM, CD-R, DVD, or the like), a magneto-optical disk (MO or the like), a semiconductor memory, or the like. The battery module 1 may be provided with only one memory or the like serving as the storage medium 4, or may be provided with a plurality of memories or the like. The storage medium 4 stores a program executed by the control circuit 2, data of a result of executing the program, and data such as a measurement result of the measurement unit 5.

In the battery module 1, a battery management unit (BMU) is configured by the control circuit 2, the storage medium 4, and the like. In other words, the battery management unit can control the first circuit breaker 32 and the connection circuit 42.

The measurement unit 5 can detect and measure the parameter related to the cell group 100 at a plurality of measurement points in a state when the cell group 100 is charged or discharged.

The current measurement circuit 51 acquires the current value of a single cell in the cell group 100.

The voltage measurement circuit 52 acquires the voltage value of the single cell in the cell group 100.

The temperature sensors 53A are directly attached to the first cell 10 and acquire the temperature of the first cell 10. The temperature sensors 53A are preferably located near the first circuit breaker 32 and the connection circuit 42. When the cell module 1 includes a plurality of temperature sensors 53A, the temperature sensors 53A are preferably disposed at least near the first circuit breaker 32 and near the connection circuit 42, and the plurality of temperature sensors are preferably close to each other. Thus, when the battery module 1 is controlled, the similar temperature range is referred to, the circuit is more reliably disconnected as the control when the first temperature is reached, and the circuit can be connected to the discharge circuit 45 as the control when the second temperature is reached. Therefore, the battery module 1 can be controlled with higher reliability. The temperature sensors 53B are attached to the second cell 20. The temperature sensors 53A may be, for example, thermosensors. The interval at which the information on the temperature is acquired is, for example, 120 milliseconds or more. The timer 54 can measure the time when the current value, the voltage value, or the temperature of the single cell in the cell group 100 is acquired.

The user interface 7 can output information related to information processing of the single cells in the cell group 100 and can receive input related to information processing of the single cells in the cell group 100 by a user of the battery module 1 or the like. Therefore, the user interface 7 is provided with an output device that outputs information related to information processing of the single cells in the cell group 100. The output device outputs information to the outside by screen display, sound transmission, vibration, or the like. The output device can output heat generation or the like of the single cell in the cell group 100 to a user in response to an instruction from the control circuit 2. The user interface 7 is provided with an input device for a user to input an operation. The input device is configured by one or more of, for example, a button, a mouse, a touch panel, a keyboard, a voice input device, and the like. The user interface 7 may be provided separately from the battery module 1.

The first circuit breaker 32 changes the connection state of the first cell 10 based on information from the control circuit 2. The first circuit breaker 32 can control the connection state of the first cell 10 by the control circuit 2, for example. The first circuit breaker 32 is installed at a position where the first circuit breaker mechanism 30 is disposed, and can be installed at at least one of 30A, 30B, 30C, and 30D in FIG. 3.

The connection circuit 42 changes the connection state of the first cell 10 based on the information from the control circuit 2. The connection circuit 42 can control the connection state of the first cell 10 by the control circuit 2, for example. The connection circuit 42 is installed at a position where the connection mechanism 40 is disposed, and can be installed at least one of a 40A and a 40B in FIG. 3.

The first circuit breaker 32 and the connection circuit 42 can switch the connection state of the circuit, and include, for example, a relay. The first circuit breaker 32 and the connection circuit 42 include, for example, a contact relay.

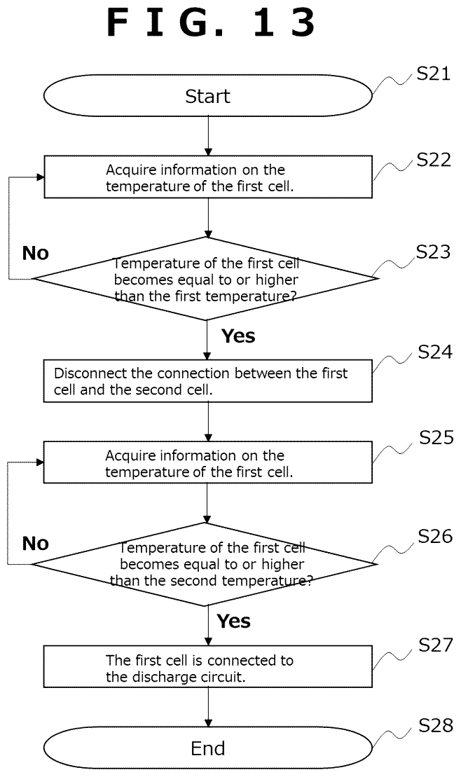

A flow of events in the battery module according to the embodiment will be described. FIG. 13 is a flowchart showing an example of a flow of events in the battery module according to the embodiment. Note that this flowchart is an example, and the order of control and the like are not limited as long as a necessary control result can be obtained. Further, the processing results may be sequentially stored in the storage medium 4, and each step may acquire the processing result by referring to the storage medium 4.

In the S21, the place where the first circuit breaker 32 is installed is conductive, and the first cell 10 is connected to the second cell 20. On the other hand, the place where the connection circuit 42 is installed is disconnected, and no current flows from the first cell 10 to the discharge circuit 45.

In S22, the control circuit 2 reads and executes the temperature acquisition program 411 to acquire information on the temperature of the first cell 10 using the temperature sensors 53A.

In the S23, the control circuit 2 reads and executes the first temperature determination program 421 to compare the temperature obtained in the S22 with the first temperature. If the temperature obtained in S22 is equal to or higher than the first temperature (YES), the process proceeds to S24. If the temperature is lower than the first temperature (NO), the process returns to S22.

In the S24, the control circuit 2 reads and executes the circuit disconnection program 422 to control the first circuit breaker 32 to break the wire at the location where the first circuit breaker 32 is installed. Thus, the first cell 10 is disconnected from the second cell 20. When the first circuit breaker 32 are installed at a plurality of locations, the control circuit 2 can control the plurality of first circuit breaker 32.

In S25, the control circuit 2 reads and executes the temperature acquisition program 411 to acquire information on the temperature of the first cell 10 using the temperature sensors 53A.

In the S26, the control circuit 2 reads and executes the second temperature determination program 423 to compare the temperature obtained in the S25 with the second temperature. If the temperature obtained in S25 is equal to or higher than the second temperature (YES), the process proceeds to S27. If the temperature is lower than the second temperature (NO), the process returns to S25.

In the S27, the control circuit 2 reads and executes the discharge circuit connection program 424 to control the connection circuit 42 to conduct the position where the connection circuit 42 is installed. As a result, the first cell 10 is connected to the discharge circuit 45.

By controlling the connection state of the circuit by the control circuit in this way, it is possible to quickly respond to the temperature.

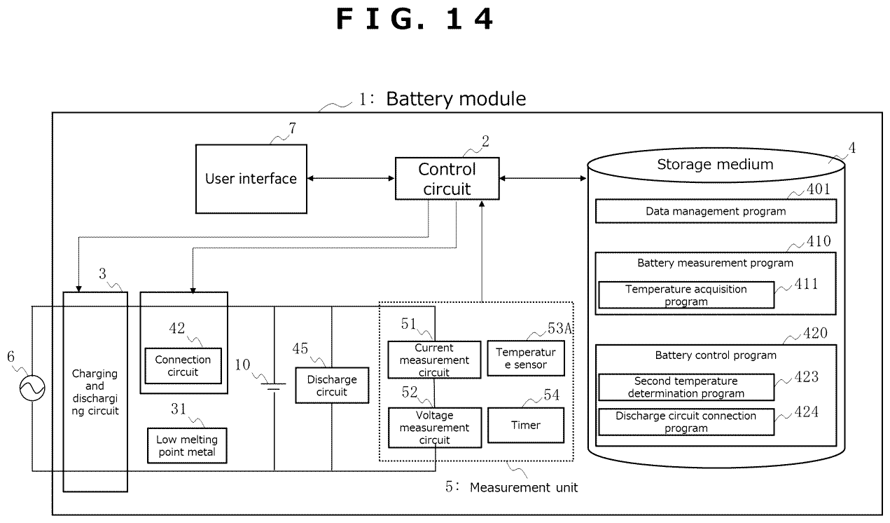

Next, a battery module in which the first circuit breaker mechanism 30 is the metal 31 and the connection mechanism 40 is the connection circuit 42 will be described. In the battery module according to the embodiment of FIG. 14, the first temperature determination program 421, the circuit disconnection program 422, and the first circuit breaker 32 are deleted from the battery control program 420 of FIG. 12, and a metal 31 is newly added. The metal 31 and the connection circuit 42 are disposed at the same positions as those described in the first and second embodiments.

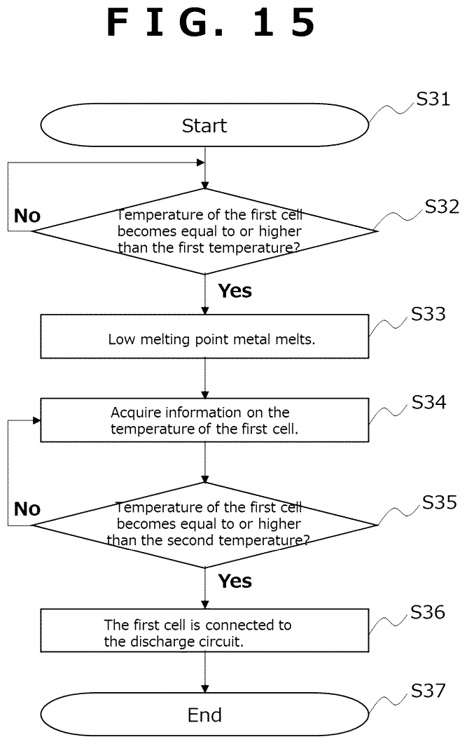

A flow of events in the battery module according to the embodiment will be described. FIG. 15 is a flowchart showing an example of a flow of events in the battery module according to the embodiment.

In S32, when the temperature of the first cell 10 becomes equal to or higher than the first temperature (YES), the process proceeds to S33. When the temperature of the first cell 10 has not reached the first temperature (NO), the S32 is repeated. The connection structure between the first bus bar 34A and the second bus bar 34B at this time is shown in FIG. 9A, and the first bus bar 34A and the second bus bar 34B are connected. On the other hand, the first bus bar 34A and the board terminals 35 are not connected to each other.

In the S33, when the temperature of the first cell 10 reaches the first temperature, the metals 31 melt, and the connection between the first bus bar 34A and the second bus bar 34B is disconnected. When the metal 31 is melted, the metal 31 is stored in the groove 38. Even if the metals 31 do not entirely move to the groove 38, the connection between the first bus bar 34A and the second bus bar 34B may be disconnected. The connection structure between the first bus bar 34A and the second bus bar 34B at this time is shown in FIG. 9B because the temperature of the first cell 10 is equal to or higher than the first temperature and lower than the second temperature.

In S34, the control circuit 2 reads and executes the temperature acquisition program 411 to acquire information on the temperature of the first cell 10 using the temperature sensors 53A.

In the S35, the control circuit 2 reads and executes the second temperature determination program 423 to compare the temperature obtained in the S35 with the second temperature. If the temperature obtained in S35 is equal to or higher than the second temperature (YES), the process proceeds to S36. If the temperature is lower than the second temperature (NO), the process returns to S34.

In the S36, the control circuit 2 reads and executes the discharge circuit connection program 424 to control the connection circuit 42 to conduct the place where the connection circuit 42 is installed. As a result, the first cell 10 is connected to the discharge circuit 45.

### Second Embodiment

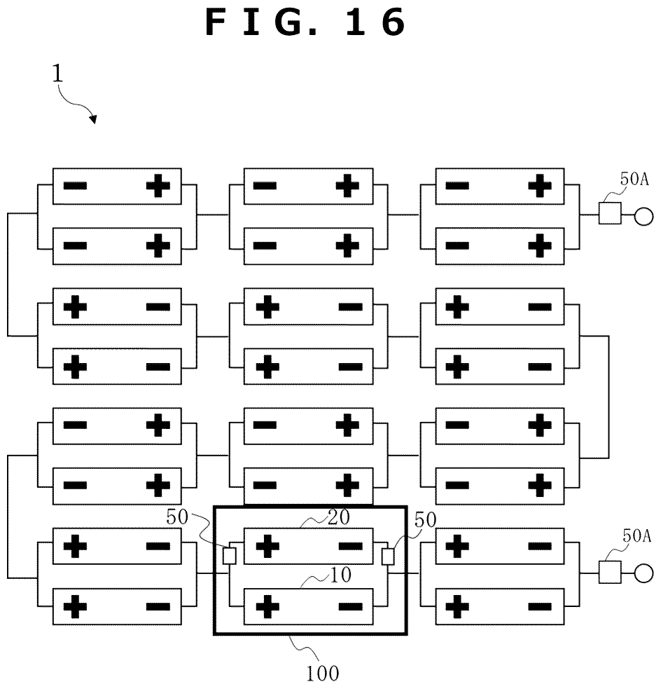

The battery module according to the second embodiment newly includes a second circuit breaker mechanism in addition to the above-described battery module. Here, a case where a plurality of cell groups 100 exist in the battery module 1 will be described with reference to FIG. 16.

FIG. 16 is a schematic view showing the connection of the single cells of the battery module 1. The battery module 1 includes 12 cell groups, and the cell groups are connected in series. The second circuit breaker mechanism 50 interrupts the connection between the cell group 100 and the other cell group according to the magnitude of the current. The second circuit breaker mechanism is, for example, a fuse. The second circuit breaker mechanism is preferably designed not to operate during normal operation in which the temperature has not reached the heat generation start temperature, but to operate when current is concentrated.

The position where the second circuit breaker mechanism can be installed will be described. The second circuit breaker mechanism 50 can be installed between the negative electrode of the first cell 10 and the negative electrode of the second cell 20, and on the second cell 20 side. Alternatively, the second circuit breaker mechanism 50 can be provided between the first cell 10 and the positive electrode of the second cell 20, and can be provided on the second cell 20 side.

When the battery module 1 includes a plurality of cell groups 100 as shown in FIG. 16, the second circuit breaker mechanism 50 may be provided at one position with respect to the entire battery module 1. For example, in the cell module 1 of FIG. 16, the second circuit breaker mechanism 50 can be installed at the start end or the terminal end (50A) of the plurality of cell groups 100 which are the module terminals. This can disconnect the current of the entire battery module 1, and can prevent a further rise in the temperature of the battery module 1. When the second circuit breaker mechanism 50 is installed in the 50A, the second circuit breaker mechanism 50 is a switch such as a field-effect transistor (FET) or a relay.

When the first cell 10 reaches the first temperature or higher and the connection between the first cell 10 and the second cell 20 or another cell group is disconnected, the current flowing through the first cell 10 flows to the second cell 20. This may cause a rapid temperature rise in the second cell 20, but the provision of the second circuit breaker mechanism can prevent the rapid temperature rise.

In the battery module according to the embodiment, the case where the cell group having a pair of parallel connection structures is formed by two single cells has been described. In the battery module according to the embodiment, for example, a cell group having a pair of parallel connection structures may be formed by three or more single cells.

In addition, the battery module according to the embodiment has been described in the case where the number of cell groups is one, but the number of cell groups may be two or more. The battery module may have a series connection structure in which a plurality of cell groups are connected in series, a parallel connection structure in which cell groups are connected in parallel, or both the series connection structure and the parallel connection structure. When a plurality of cell groups exist in the cell module, it is desirable that the first circuit breaker 32 is provided in one of 30A and 30B and in one of 30E and 30F in FIG. 7, and the control circuit 2 can control the plurality of first circuit breakers 32. Alternatively, the first circuit breaker 32 is desirably provided in either 30C or 30D. Thus, for example, even when the temperature of the first cell 10 becomes equal to or higher than the first temperature, it is possible to prevent an excessive current from flowing from the cell group of another set to the second cell 20 and prevent the temperature from rapidly rising.

The battery module may be in the form of a battery string, a battery array, or the like in which a plurality of battery modules are electrically connected. In a battery module in which cell groups are electrically connected, each of the cell groups may be individually controlled, or some of the cell groups may be grouped and controlled for each group.

Although the example in which the metal 31 is used for the first circuit breaker mechanism 30 and the connection circuit 42 is used for the connection mechanism 40 has been described, the first circuit breaker 32 may be used for the first circuit breaker mechanism 30 and the insulator 41 may be used for the connection mechanism 40.

### Third Embodiment

According to a third embodiment, a vehicle is provided. The vehicle is equipped with the battery module according to the embodiment.

In the vehicle according to the third embodiment, the battery module recovers, for example, regenerative energy of power of the vehicle. The vehicle may include a mechanism (regenerator) that converts kinetic energy of the vehicle into regenerative energy.

Examples of the vehicle according to the third embodiment include two- to four wheel hybrid electric vehicles, two- to four wheel electric vehicles, assist bicycles, and railway vehicles.

The mounting position of the battery module in the vehicle according to the third embodiment is not particularly limited. For example, when the battery module is mounted on an automobile, the battery module can be mounted in an engine room of the vehicle, at the rear of the vehicle body, or under a seat.

The vehicle according to the third embodiment may be equipped with a plurality of battery modules. In this case, when each battery module includes a cell group including a plurality of single cells, the cell groups may be connected in series, in parallel, or in a combination of series connection and parallel connection.

Next, an example of a vehicle according to a third embodiment will be described with reference to the drawings.

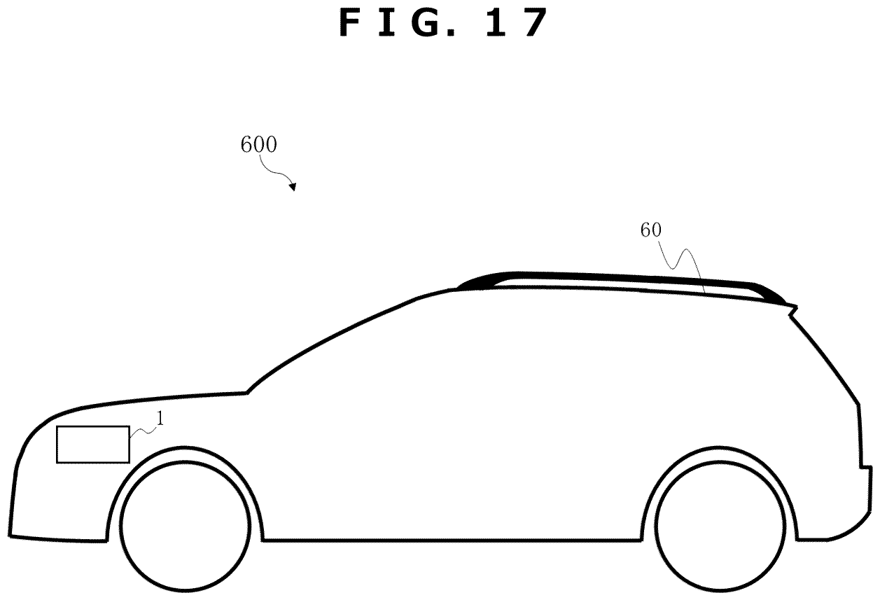

FIG. 17 is a partially transparent view schematically showing an example of the vehicle according to the third embodiment.

A vehicle 600 shown in FIG. 17 includes a vehicle body 60 and the battery module according to the embodiment. In the example shown in the figure, the vehicle 600 is a four wheeled automobile.

The vehicle 600 may be equipped with a plurality of battery modules 1. In this case, the cell groups included in the battery module 1 may be connected in series, may be connected in parallel, or may be connected by combining the series connection and the parallel connection.

FIG. 17 illustrates an example in which the battery module 1 is mounted in an engine room located in front of the vehicle body 60. As described above, the battery module 1 may be mounted, for example, on the rear side of the vehicle body 60 or under the seat. The battery module 1 can be used as a power supply of the vehicle 600. The battery module 1 can also recover regenerative energy of the power of the vehicle 600.

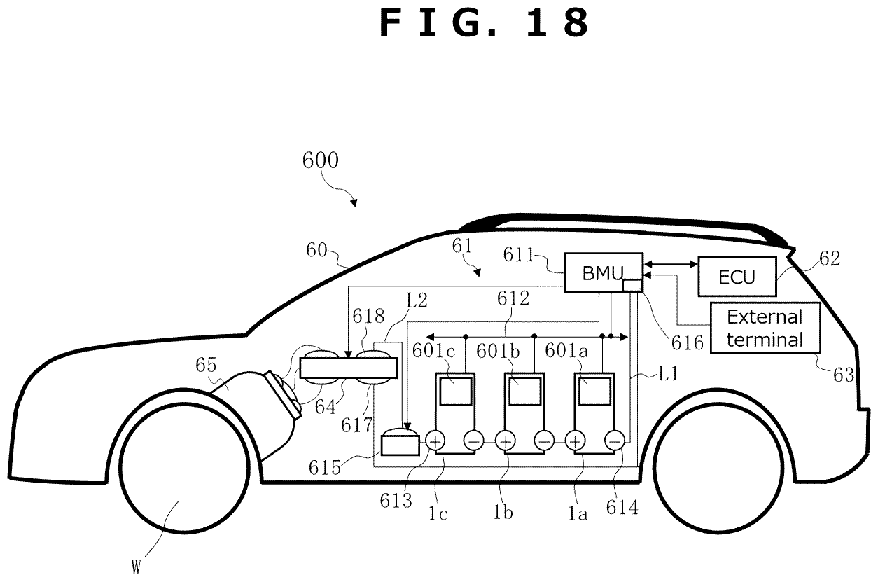

Next, an aspect of the vehicle according to the third embodiment will be described with reference to FIG. 18.

FIG. 18 is a diagram schematically showing an example of a control system related to an electrical system in the vehicle according to the third embodiment. The vehicle 600 shown in FIG. 18 is an electric vehicle.

A vehicle 600 shown in FIG. 18 includes a vehicle body 60, a vehicle power supply 61, an electric control unit (ECU) 62 that is a control device at a higher level than the vehicle power supply 61, an external terminal (a terminal for connection to an external power supply) 63, an inverter 64, and a drive motor 65.

The vehicle 600 is equipped with the vehicle power supply 61, for example, in an engine room, at the rear of the vehicle body of the automobile, or under a seat. In the vehicle 600 shown in FIG. 18, the location where the vehicle power supply 61 is mounted is schematically shown.

The vehicle power supply 61 includes a plurality of (for example, three) cell modules 1a, 1b, and 1c, a battery management unit 611, and a communication bus 612.

The cell modules 1a, 1b, and 1c are cell modules similar to the cell module 1 described above, and are connected in series.

The cell modules 1a, 1b, and 1c can be removed independently of each other and replaced with other cell modules 1.

The cell modules 1a, 1b, and 1c are charged and discharged through the positive electrode terminals 613 and the negative electrode terminals 614, respectively.

The cell modules 1a to 1c measure the voltage and temperature of each single cell constituting the cell module based on a command from the battery management unit 611 by communication. However, the temperature can be measured at only several locations per battery module, and the temperature of all the single cells need not be measured. When the cell modules 1a to 1c do not include the control circuit and the measurement unit described above, the cell modules 1a to 1c can newly include module monitoring devices 601a (for example, VTM: Voltage Temperature Monitoring), 601b, and 601c, respectively. The module monitoring devices 601a to 601c communicate with the battery management unit 611 described later. Here, a case when the module monitoring devices 601a to 601c are not provided will be described.

The battery management unit 611 communicates with the cell modules 1a to 1c, and collects information on the voltage, temperature, and the like of each of the single cells included in the cell modules 1a to 1c included in the vehicle power supply 61. Thus, the battery management unit 611 collects information on the maintenance of the vehicle power supply 61.

The battery management unit 611 and the cell modules 1a, 1b, and 1c are connected via a communication bus 612. In the communication bus 612, one set of communication lines is shared by a plurality of nodes (the battery management unit 611 and one or more cell modules 1a to 1c). The communication bus 612 is a communication bus configured based on, for example, a control area network (CAN) standard.

The vehicle power supply 61 may include an electromagnetic contactor (for example, a switch device 615 illustrated in FIG. 18) that switches connection and disconnection between the positive electrode terminal 613 and the negative electrode terminal 614. The switch device 615 includes a pre-charge switch (not shown) that is turned on when the cell modules 1a to 1c are charged, and a main switch (not shown) that is turned on when the output from the cell modules 1a to 1c is supplied to the load. Each of the pre-charge switch and the main switch includes a relay circuit (not shown) that is switched on or off by a signal supplied to a coil disposed near the switch mechanism. The electromagnetic contactor such as the switch device 615 is controlled based on a control signal from the battery management unit 611 or the electric control unit 62 that controls the operation of the entire vehicle 600.

The inverter 64 converts the input DC voltage into a three phase AC high voltage for driving the motor. The three phase output terminals of the inverter 64 are connected to the three phase input terminals of the drive motor 65. The inverter 64 is controlled based on a control signal from the battery management unit 611 or the electric control unit 62 for controlling the operation of the entire vehicle. The inverter 64 is controlled, and thereby, the output voltage from the inverter 64 is adjusted.

The drive motor 65 is rotated by the electric power supplied from the inverter 64. The driving force generated by the rotation of the drive motor 65 is transmitted to the axle and the drive wheels W via, for example, a differential gear unit.

Although not shown, the vehicle 600 includes a regenerative brake mechanism (regenerator). The regenerative brake mechanism rotates the drive motor 65 when the vehicle 600 is braked, and converts kinetic energy into regenerative energy as electric energy. The regenerative energy recovered by the regenerative brake mechanism is input to the inverter 64 and converted into a direct current. The converted direct current is input to the vehicle power supply 61.

One of terminals of a connection line L1 is connected to the negative electrode terminal 614 of the vehicle power supply 61. The other end of the connection line L1 is connected to the negative electrode input terminal 617 of the inverter 64. A current detection unit (current detection circuit) 616 in the battery management unit 611 is provided between the negative electrode terminals 614 and the negative electrode input terminals 617 on the connection line L1.

One of terminals of a connection line L2 is connected to the positive electrode terminal 613 of the vehicle power supply 61. The other end of the connection line L2 is connected to the positive electrode input terminal 618 of the inverter 64. The connection line L2 is provided with a switch device 615 between the positive electrode terminals 613 and the positive electrode input terminals 618.

The external terminal 63 is connected to the battery management unit 611. The external terminal 63 can be connected to, for example, an external power supply.

The electric control unit 62 cooperatively controls the vehicle power supply 61, the switch device 615, the inverter 64, and the like together with other management devices and control devices including the battery management unit 611 in response to an operation input by a driver or the like. The electric control unit 62 and the like cooperatively control the output of electric power from the vehicle power supply 61, the charging of the vehicle power supply 61, and the like, and manage the entire vehicle 600. Data related to the maintenance of the vehicle power supply 61, such as the remaining capacity of the vehicle power supply 61, is transferred between the battery management unit 611 and the electric control unit 62 via the communication line.

According to one or more embodiments and examples described above, a battery module is provided that includes a first circuit breaker mechanism that disconnects the connection between a first cell and a second cell when the temperature of the first cell is equal to or higher than a first temperature in a cell group in which the first cell and the second cell are connected in parallel, and a connection mechanism that connects the first cell to a discharge circuit when the temperature of the first cell is equal to or higher than a second temperature higher than the first temperature. The battery module according to the embodiment can provide a battery module capable of alleviating a rapid temperature rise.

In the present specification, the embodiment has been described by using the lithium-ion secondary battery as an example of the single cell, but the type of the single cell is not limited to the lithium-ion secondary battery such as a nickel-metal hydride battery.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. These embodiments and modifications thereof are included in the scope and spirit of the invention, and are included in the invention described in the claims and the scope of equivalents thereof.

The invention of the embodiment will be described below.

<1>

A battery module includes
a cell group in which a first cell and a second cell are connected in parallel,
a first circuit breaker mechanism configured to disconnect connection between the first cell and the second cell when a temperature of the first cell is equal to or higher than a first temperature, and
a connection mechanism configured to connect the first cell to a discharge circuit when the temperature of the first cell is equal to or higher than a second temperature higher than the first temperature.
   <2>

The battery module according to <1>, wherein
the first circuit breaker mechanism is made of a metal that melts at the first temperature or higher, and
the connection mechanism is an insulator that melts at the second temperature or higher.
   <3>

The battery module according to <1>, wherein
the first circuit breaker mechanism includes a first circuit breaker, and
the connection mechanism includes a connection circuit.
   <4>

The battery module according to <3>, further includes
a control circuit is configured to acquire information on a temperature of the first cell, wherein
when the temperature of the first cell is equal to or higher than the first temperature, the first cell and the second cell are disconnected from each other based on information from the control circuit, and
when the temperature of the first cell is equal to or higher than the second temperature, the first cell and the discharge circuit are connected to each other based on information from the control circuit.
   <5>

The battery module according to <1>, further includes a control circuit, wherein
the first circuit breaker mechanism is one of a metal that melts at the first temperature or higher and a first circuit breaker that operates based on information from a control circuit,
the connection mechanism is one of an insulator that melts at the second temperature or higher and a connection circuit that operates based on information from the control circuit, and
the control circuit is configured to acquire information on a temperature of the first cell.
   <6>

The battery module according to any one of <1>to <5>, further includes a second circuit breaker mechanism, wherein
the second circuit breaker mechanism is configured to disconnect connection between the cell group and another single cell in the battery module.
   <7>

A vehicle includes
the vehicle that includes the battery module according to any one of <1>to <6>.

What is claimed is:

1. A battery module comprising:
a cell group in which a first cell and a second cell are connected in parallel,
a first circuit breaker mechanism configured to disconnect connection between the first cell and the second cell when a temperature of the first cell is equal to or higher than a first temperature, and
a connection mechanism configured to connect the first cell to a discharge circuit when the temperature of the first cell is equal to or higher than a second temperature higher than the first temperature.

2. The battery module according to claim 1, wherein
the first circuit breaker mechanism is made of a metal that melts at the first temperature or higher, and
the connection mechanism is an insulator that melts at the second temperature or higher.

3. The battery module according to claim 1, wherein
the first circuit breaker mechanism includes a first circuit breaker, and
the connection mechanism includes a connection circuit.

4. The battery module according to claim 3, further comprising
a control circuit is configured to acquire information on a temperature of the first cell, wherein
when the temperature of the first cell is equal to or higher than the first temperature, the first cell and the second cell are disconnected from each other based on information from the control circuit, and
when the temperature of the first cell is equal to or higher than the second temperature, the first cell and the discharge circuit are connected to each other based on information from the control circuit.

5. The battery module according to claim 1, further comprising a control circuit, wherein
the first circuit breaker mechanism is one of a metal that melts at the first temperature or higher and a first circuit breaker that operates based on information from a control circuit,
the connection mechanism is one of an insulator that melts at the second temperature or higher and a connection circuit that operates based on information from the control circuit, and
the control circuit is configured to acquire information on a temperature of the first cell.

6. The battery module according to claim 1, further comprising a second circuit breaker mechanism, wherein
the second circuit breaker mechanism is configured to disconnect connection between the cell group and another single cell in the battery module.

7. A vehicle comprising:
the vehicle that includes the battery module according to claim 1.

8. A vehicle comprising:
the vehicle that includes the battery module according to claim 2.

9. A vehicle comprising:
the vehicle that includes the battery module according to claim 3.

10. A vehicle comprising:
the vehicle that includes the battery module according to claim 4.

11. A vehicle comprising:
the vehicle that includes the battery module according to claim 5.

12. A vehicle comprising:
the vehicle that includes the battery module according to claim 6.
